(19) United States
(12) Patent Application Publication
(10) Pub. No.: US 2009/0123736 A1
(43) Pub. Date: May 14, 2009

(54) REPULPABLE PACKAGING MATERIALS WITH REINFORCEMENT

(76) Inventor: Terrell J. Green, Raleigh, NC (US)

Correspondence Address: MEADWESTVACO CORPORATION;ATTN: IP LEGAL DEPARTMENT, 1021 MAIN CAMPUS DRIVE, RALEIGH, NC, 27606, US

(21) Appl. No.: 12/355,032

(22) Filed: Jan. 16, 2009

Related U.S. Application Data
(63) Continuation-in-part of application No. 11/158,183, filed on Jun. 21, 2005.

(51) Int. Cl. B32B 27/10; C08K 5/05

(52) U.S. Cl. 428/334; 524/388; 428/511; 428/339

(57) ABSTRACT

A repulpable packaging material is disclosed that contains reinforcement to enhance strength property. The packaging material includes a repulpable substrate, and a reinforcement material applied to the substrate. The reinforcement material comprises an aqueous-soluble polyvinyl alcohol (PVA) but excluding rosin-based compound. The reinforcement material may further include a plasticizer. When desired, the reinforcement material may consist essentially of about 0%-50% weight of ethylene glycol plasticizer and about 50%-100% weight of aqueous-soluble PVA polymer.

This is a continuation-in-part application of co-pending and commonly assigned U.S. patent application Ser. No. 11/158,183 filed Jun. 21, 2005, which is incorporated herein by reference.

### BACKGROUND OF THE DISCLOSURE

Articles such as cans or bottles for beverages including soft drink, beer, juices and the like are commonly sold in multiple quantities packaged in a paperboard carton. To enhance handling convenience for the consumers, the carton is often provided with a handle which commonly includes as a primary feature one or two slots or other apertures formed in the carton. The user inserts the hand or fingers into one or both of the slots to lift the carton. Many varieties of handles are known in the art including glued handles.

One critical functional property for the carton carrier is the structural integrity. The carton carrier must be able to withstand stress of cyclic loading during transportation, as well as during storage under high moisture conditions like in the refrigerator. The stress impact is particularly high for certain parts of the carrier such as the handles, the top panel, as well as the connections between the top and bottom panel and the side panels. Accordingly, various methods have been developed to reinforce and enhance the strength of paperboard-based packaging materials.

U.S. Pat. No. 4,617,223 discloses a reinforced paperboard carton having selected areas reinforced with polyurethane polymer. The selected areas of a paperboard carton blank are impregnated with a polyisocyanate which reacts with hydroxyl groups within the paperboard to form a cured polyurethane reinforcement. Polyurethane is not repulpable, and there has been increasing concerns of using non-repulpable materials for packaging applications.

U.S. Patent Publication No. 2006/0068674 describes a medical packaging material with enhanced strength, holdout and printability. The packaging material comprises a coated paper laminated with a layer of non-woven fabric selected from the group consisting of polyester, polypropylene, polyethylene, nylon, polytetrafluoroethylene, polyvinylfluoride, polyvinylchloride, polyvinylidenefluoride, and polyvinylidenechloride. The coated paper is prepared by coating the paper substrate with a polyvinyl alcohol to provide water holdout properties. The non-woven fabric is to impart reinforcement and increase strength properties of the coated board.

U.S. Pat. No. 4,567,070 discloses a reinforced paperboard container having a reinforcing flexible tape sandwich between two paperboard layers. The reinforcing tape contains reinforced polymeric fibers bound together by an adhesive. The reinforced fibers are made of synthetic fiber yarns such as polyamide, rayon, polyethylene, polypropylene and the like; all of which are not repulpable. Adhesives suitable for binding such reinforced fibers are polyvinyl alcohol or polyvinyl acetate. Polyvinyl alcohol functions solely as an adhesive, while reinforced fibers attribute to the enhanced strength property of the container.

PCT Patent Publication No. WO 2008/008576 teaches a reinforced paperboard carton having fibers with a dimension of about 50-2,000 microns in length and about 20-1,000 microns in diameter as a reinforcement material. The desired areas of the paperboard are selectively coated with an aqueous solution containing a water-based polymeric binder and the micron-sized reinforced fibers. Examples of suitable water-based polymeric binders are polyvinyl alcohol, acrylic, urethane, polyester, styrene-acrylic, styrene-butadiene, vinyl acetate, vinyl-acrylic, acrylic-vinyl acetate, epoxy, vinyl, and combinations thereof. The polymeric binder, such as polyvinyl alcohol, facilitates the adhesion of the reinforced, micron-sized fibers to the paperboard. One drawback of this reinforced paperboard carton is that the reinforced fiber is rather expensive because complex techniques are required for a production of fibers in micron size. Consequently, the manufacturing-scale production of this reinforced paperboard is limited because of high production cost.

Water-soluble polyvinyl alcohol has been used as binder or adhesive to facilitate the adhesion of reinforcement material to the paperboard substrates. It is well-recognized that coating the paperboard with mere water-soluble polyvinyl alcohol does not provide sufficient strength properties, especially when the paperboard is to be used as a packaging material for high stress applications such as beverage carriers. Japanese Publication No. 08092537 teaches a water-soluble hot-melt adhesive comprising (a) polyvinyl alcohol (PVA); (b) a water-soluble or water-dispersible rosin or rosin derivative or salt thereof, and (c) a water-soluble or water-dispersible plasticizer. The rosin-based component is critical in imparting to the hot-melt adhesive an improved stability and enhanced set time. The PVA-based adhesive without rosin-based compound has insufficient thermal stability and poor set time for practical use. In particular, the hot-melt adhesive containing only PVA polymer and an organic plasticizer, such as glycerin or ethylene glycol, is reported unsuitable for high-speed adhesion purpose. U.S. Pat. No. 6,193,831 discloses a coated sheet material with enhanced barrier and release properties that is suitable as an ovenable coated sheet. The coated material is produced by coating a porous substrate sheet with a barrier coating composition, and subsequently coating the resulting coated sheet with a release coating composition. The barrier coating composition comprises (a) a cross-linkable polymer to provide moisture barrier property; and (b) a water-dispersible film-forming polymer to provide grease and oil resistant property. Polyvinyl alcohol may be used as a cross-linkable polymer and a water-dispersible film-forming polymer. One skilled in the art recognizes that barrier properties are distinctive from strength properties. Barrier properties are a surface characteristic that depends on surface porosity; whereas, strength properties are a physical characteristic. Tear strength is commonly used for determining the strength (i.e., toughness) of the paperboard packaging materials, particularly for beverage carriers. It is a measurement of the force required to tear the paperboard, and the Elmerdorf tear tester is widely used for such determination. The PVA layer neither improves the strength nor renders reinforcement property to the coated sheet material. To achieve sufficient strength and dimension stability for practical use, an additional layer of E-fluted corrugated paperboard must be incorporated into the PVA-coated sheet structure.

The paperboard beverage carriers containing water-soluble polyvinyl alcohol typically require a reinforcement material in order to achieve desired strength property. Synthetic polymers, such as polyethylene and polypropylene, in fibrous or sheet forms are commonly used as reinforcement materials for such applications. Unfortunately, these reinforced polymeric materials are not repulpable. With increased concerns for the environment, it is desirable to have packaging materials that can be easily disposed of and/or recycled. It is further beneficial to have a paperboard packaging material that is repulpable.

To address the repulpable property while maintaining a desirable strength property of the packaging materials, U.S. Patent Publication No. 2005/0092451 discloses a method of producing a paper-based material having enhanced strength performance. A regenerated cellulose fiber is mixed with a reinforced fiber and a water soluble binder. Then, the resulting mixture is subjected to a papermaking process to provide a reinforced paper-based sheet. Examples of the reinforced fibers are polyethylene terephthalate fibers, nylon fibers, polyolefin fibers, synthetic wood pulp fibers, polyvinyl alcohol fibers, acrylic fibers, modified acrylic fibers, vinyl chloride fibers, vinylidene chloride fibers, acetate fibers, regenerated protein fibers, polylactide fibers, poly(lactide-co-glycolide- ) fibers, glass fibers, ceramic fibers, metal fibers, mineral fibers, or combinations thereof. The water soluble binder may be carboxymethyl cellulose, polyethylene oxide, polyvinyl alcohol, protein, polyacrylic acid, starches, gums, or combinations thereof. One drawback of this process is that a relatively high level of reinforced fibers is needed to achieve the paper-based material with desired strength. As a result, this process has rather high production cost. Additionally, since reinforced fibers are added into the fiber slurry before the papermaking process, the reinforced fibers are distributed throughout the formed paper sheet. As such, a selective reinforcement at only certain areas of the sheet structure becomes impossible.

Accordingly, there is a need for packaging materials that are repulpable, yet provide excellent strength property for high stress packaging applications such as for use as beverage carriers.

### SUMMARY OF THE DISCLOSURE

A repulpable packaging material is disclosed that contains reinforcement to enhance strength property. The packaging material includes a repulpable substrate and a reinforcement material applied to the substrate. The reinforcement material comprises an aqueous-soluble polyvinyl alcohol (PVA) but excluding a rosin-based compound. The reinforcement material may further include a plasticizer. When desired, the reinforcement material may consist essentially of about 0%-50% weight of ethylene glycol plasticizer and about 50%-100% weight of aqueous-soluble PVA polymer.

### DESCRIPTION OF DRAWINGS

FIG. 1 is a top plan view of one embodiment of the disclosed carrier carton;

FIG. 2 is a top plan view of one embodiment of the disclosed carrier carton; and

FIG. 3 is a top plan view of one embodiment of the disclosed carrier carton.

### DESCRIPTION OF THE DISCLOSURE

The present disclosures now will be described more fully hereinafter, but not all embodiments of the disclosure are necessarily shown. While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof.

A repulpable packaging material of the present disclosure comprises:

(a) a repulpable substrate; and

(b) a reinforcement material including an aqueous-soluble polyvinyl alcohol (PVA) but excluding rosin-based compound, applied to the substrate.

In one embodiment of the present disclosure, the repulpable packaging material comprises:

(a) a repulpable substrate; and

(b) a reinforcement material including an aqueous-soluble polyvinyl alcohol (PVA) and a plasticizer, but excluding rosin-based compound, applied to the substrate.

In one embodiment of the present disclosure, the repulpable packaging material comprises:

(a) a repulpable substrate; and

(b) a reinforcement material including:
(i) from 50% to 100% weight of an aqueous-soluble polyvinyl alcohol, and
(ii) up to 50% weight of plasticizer, but excluding a rosin-based compound.

In one embodiment of the present disclosure, the repulpable packaging material comprises:

(a) a repulpable substrate; and

(b) a reinforcement material including:
(i) from 80% to 100% weight of an aqueous-soluble polyvinyl alcohol, and
(ii) up to 20% weight of plasticizer, but excluding a rosin-based compound.

In one embodiment of the present disclosure, the ethylene glycol is used as a plasticizer.

In one embodiment of the present disclosure, the reinforce material consists essentially of an aqueous-soluble polyvinyl alcohol polymer and ethylene glycol plasticizer.

In one embodiment, the reinforce material further excludes any crosslinker.

When desired, the reinforcement material may include additives, such for example as additives to prevent degradation of the polyvinyl alcohol film due to heat or light, and additives to give a tack-free film.

The repulpable substrate may be any substrate capable of being broken down and dispersed in an aqueous solution or capable of being repulped. For example, the repulpable substrate may be various grades of hardwood, softwood and the like and may include furnish of up to 100% recycled fiber. In one embodiment of the present disclosure, the repulpable substrate is a paper or paperboard. The substrate may have a thickness of about 1-100 points. For example, the substrate may be a 24 point paperboard blank.

The reinforcement material may be applied onto the substrate at a thickness of about 1 mil to about 5 mils. In one embodiment of the present disclosure, the thickness of the reinforcement material on the substrate is about 0.01 mils to about 10 mils.

The reinforcement material may be applied onto the substrate in liquid or solid forms. When the reinforcement material is applied as liquid onto the substrate, any known liquid coating applications may be used. When the reinforcement material is applied onto the substrate as a sheet structure, any known techniques for adhering sheet structure may be used. These include, but are not limited to, gluing, using adhesives, laminating and the like. The adhesive used for adherence of the reinforcement to the substrate may be water-based adhesive, water-soluble adhesive, or combinations thereof. In one embodiment of the present disclosure, water-soluble vinyl acetate is used as adhesive.

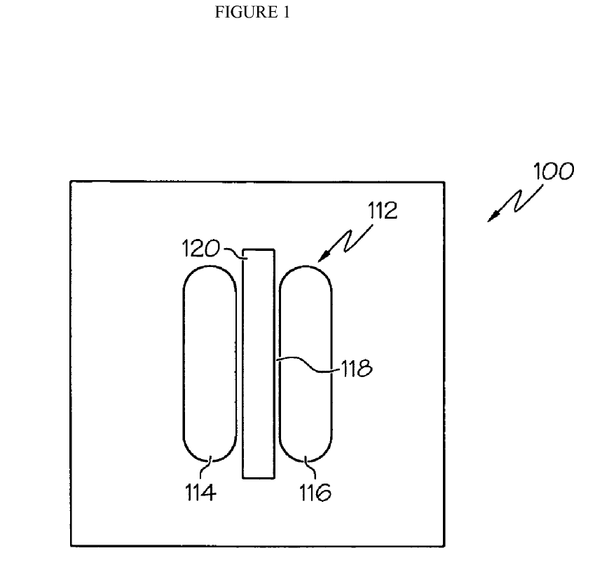

The reinforcement material may be applied onto the substrate at any location desired for enhanced strength. In particular, the reinforcement material may be applied to the substrate at areas of weakness. FIGS. 1-3 show examples of locations that the reinforcement materials may be applied to the packaging materials.

FIG. 1 shows a top view of one embodiment of the disclosed carrier carton. The carrier carton substrate 100 has a racetrack-type carry handle 112 that includes two openings 114, 116; and a gripping portion 118 positioned between the two openings 114, 116. The openings 114, 116 may be sized to receive a human hand, thereby allowing a user to grasp the gripping portion 118 for lifting and carrying the carton 100. A strip 120 of the reinforcement material is applied to the gripping portion 118 of the handle 112.

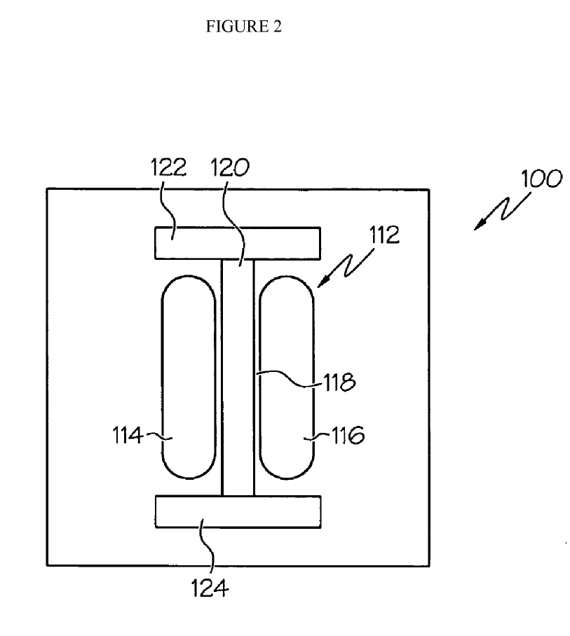

In FIG. 2, the carrier carton substrate 100 has three strips 120, 122, 124 of the reinforcement material applied in a generally H-shaped configuration.

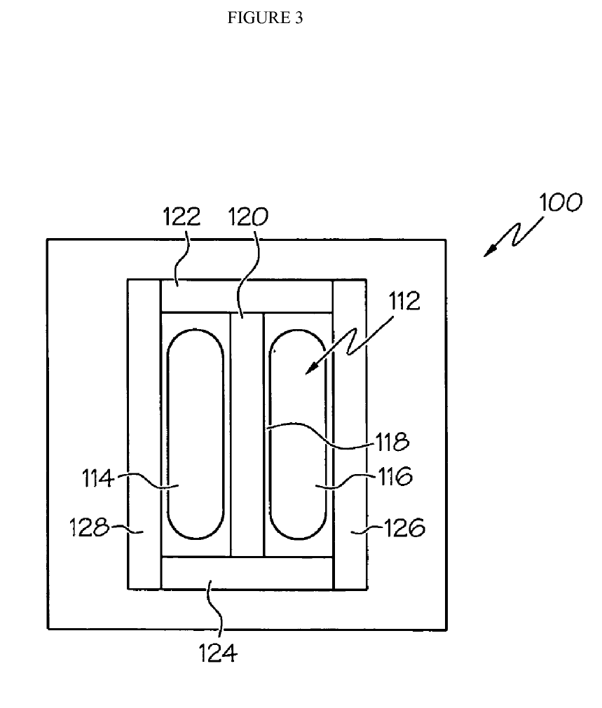

In FIG. 3, the carrier carton substrate 100 has five strips 120, 122, 124, 126, 128 of the reinforcement material applied to the substrate.

Additionally, the reinforcement material may be applied to various portions of the substrate, such as the seams, the edges, or the entire surface of the substrate.

It should be understood that FIGS. 1-3 are only illustrative and that various areas and patterns of reinforcement are within the scope of the present disclosure. Furthermore, it should be understood that the reinforcement material may be used to reinforce substrates other than cartons having racetrack-type carry handles.

### EXPERIMENTS

[1] Tear Strength Performance

Three different reinforcement materials were prepared: one with about 100% wt PVA (i.e., no plasticizer); one with about 90% wt PVA and 10% wt plasticizer; and one with about 80% wt PVA and 20% wt plasticizer. Each reinforcement material was drawn into films having different thicknesses: 2 mils, 3 mils and 4 mils.

Ten blanks of an 18 point paperboard were obtained for use as a substrate. One substrate blank was set aside as a control. The remaining nine substrate blanks were laminated with the nine different films (using glue), as indicated in TABLE 1. The resulting reinforced substrate blanks were subjected to Elmendorf tear testing.

The disclosed packaging materials containing the PVA-based reinforcement materials had substantially higher tear strength resistance compared to the control packaging material containing no reinforcement material. Furthermore, the higher level of the PVA-based reinforcement materials on the packaging materials (i.e., thicker reinforcement film), the higher level of tear resistance. The PVA-based reinforcement material of the present disclosure is capable of increasing the tear strength of treated paperboard packaging materials by at least 300 percent.

TABLE 1

| Thickness of | Composition of | | |
|---|---|---|---|
| Reinforcement | Reinforcement Material | | Tear Strength |
| Material | PVA (% wt) | Plasticizer (% wt) | (grams force) |
| 0 mils (Control) | — | — | 440.3 |
| 2 mils | 100 | 0 | 697.0 |
| | 90 | 10 | 769.3 |
| | 80 | 20 | 714.2 |
| 3 mils | 100 | 0 | 878.7 |
| | 90 | 10 | 973.4 |
| | 80 | 20 | 1133.4 |
| 4 mils | 100 | 0 | 943.4 |
| | 90 | 10 | 1210.2 |
| | 80 | 20 | 1550.4 |

[2] Repulpability Performance

Paperboard substrates coated with the reinforcement material at two difference thicknesses were prepared: 2 mil- thickness and 4-mil thickness. The repulpability of the reinforced paperboards was tested and compared to that of the control substrate containing no reinforcement material. (TABLE 2) A repulper was adjusted to a neutral pH and 120° F. Each reinforced paperboard was introduced into the repulper, and its repulpability was determined, based on % accepts and % rejects, at two different time periods: 15 minutes and 30 minutes.

TABLE 2

| | | Control | | |
|---|---|---|---|---|
| Pulping Time | Pulpability | (No Reinforced Material) | 2 mils | 4 mils |
| 15 mins | % Accepts | 31.1% | 25.2% | 25.6% |
| | % Rejects | 68.9% | 74.8% | 74.3% |
| 30 mins | % Accepts | 38.1% | 34.7% | 33.3% |
| | % Rejects | 61.9% | 65.3% | 66.7% |

The disclosed packaging materials containing the PVA-based reinforcement materials, either at 2-mil or 4-mil thicknesses, were repulpable almost as well as control packaging materials containing no reinforcement material.

Accordingly, the reinforced packaging material of the present disclosure has enhanced strength property, yet it is repulpable. The disclosed reinforced packaging material has high tear strength, allowing its use in the high stress packaging applications such as beverage carriers.

Additionally, the disclosed reinforcement material may be applied to a repulpable packaging material as a film at a thickness of about 0.1-10 mils to substantially improve the tear strength of the packaging material, while allowing the material to be easily repulped due to the water soluble nature of polyvinyl alcohol. Furthermore, it should be apparent that by varying the amount of plasticizer and/or the film thickness, those skilled in the art may be able to obtain a reinforced and repulpable substrate having improved tear strength.

While the invention has been described by reference to various specific embodiments, it should be understood that numerous changes may be made within the spirit and scope of the inventive concepts described. It is intended that the invention not be limited to the described embodiments, but will have full scope defined by the language of the following claims.

We claim:

1. A reinforced packaging material, including:
(a) a repulpable substrate; and
(b) a reinforcement material comprising an aqueous-soluble polyvinyl alcohol but excluding a rosin-based compound, applied to the substrate.

2. The reinforced material of claim 1, wherein the reinforcement material comprises an aqueous-soluble polyvinyl alcohol and a plasticizer but excluding a rosin-based compound.

3. The reinforced material of claim 2, wherein the reinforcement material comprises:
(a) from about 50% to about 100% by weight of the polyvinyl alcohol; and
(b) up to about 50% by weight of the plasticizer.

4. The reinforced material of claim 2, wherein the reinforcement material comprises:
(a) from about 80% to about 100% by weight of the polyvinyl alcohol; and
(b) up to about 20% by weight of the plasticizer.

5. The reinforced material of claim 2, wherein the plasticizer includes ethylene glycol.

6. The reinforced material of claim 2, wherein the reinforcement material consists essentially of the aqueous-soluble polyvinyl alcohol and the plasticizer.

7. The reinforced material of claim 6, wherein the plasticizer includes ethylene glycol.

8. The reinforced material of claim 1, wherein the repulpable substrate includes paperboard.

9. The reinforced material of claim 1, wherein the repulpable substrate is a paperboard carrier carton including a racetrack-type carry handle, and wherein the reinforcement material is applied to the carry handle.

10. The reinforced material of claim 1, wherein the reinforcement material is applied to the repulpable substrate as a film sheet.

11. The reinforced material of claim 10, wherein the reinforcement film has a thickness in a range of about 0.01 mils and about 10 mils.

12. The reinforced material of claim 1, wherein the reinforcement material is applied to the repulpable substrate as liquid, and then the liquid is allowed to dry into a film.

13. The reinforced material of claim 12, wherein the reinforcement film has a thickness in a range of about 1 mil and about 5 mils.
